(19) United States
(12) Patent Application Publication
(10) Pub. No.: US 2007/0278913 A1
(43) Pub. Date: Dec. 6, 2007

(54) Mobile tool chest with a safety device

(76) Inventor: Heng-Chia Liu, Taichung Hsien (TW)

Correspondence Address: Rabin & Berdo, P.C., Suite 500, 1101 14th Street, Washington, DC, 20005, US

(21) Appl. No.: 11/446,413

(22) Filed: Jun. 5, 2006

(51) Int. Cl. E05C 7/06

(52) U.S. Cl. 312/220

(57) ABSTRACT

A mobile tool chest with a safety device has a chest, a top cover, locking strips and drawers. The chest has a top. The top cover is pivotally attached pivotally to the top of the cabinet. The locking strips are slidably mounted inside the chest and are connected to the top cover and have locking holes and inner surfaces. The locking holes are formed through the inner surfaces of the locking strips. The drawers are mounted slidably in the chest, and each drawer has a rear end and a hook. The hooks are attached respectively to and protrude from the rear ends of the drawers and selectively engage the locking holes in locking strips when the top cover is closed. When the top cover is closed, the locking strips still allow the drawers to push back into the chest and the locking strips still can lock the drawers.

### BACKGROUND OF THE INVENTION

1. Field of the Invention

The present invention relates to a mobile tool chest, and more particularly to a mobile tool chest with a safety device that prevents drawers of the tool chest from inadvertently sliding out.

2. Description of Related Art

With reference to FIGS. 6, 7 and 8, a conventional mobile tool chest comprises a chest (90), a top cover (91), a locking strip (92) and multiple drawers (93).

The chest (90) has a top, a bottom, a front, a rear, two sides, multiple panels and multiple drawer openings. Panels on the bottom, front, rear and sides are welded together to form the chest (90). The drawer openings are formed through the front of the chest (90).

The top cover (91) is attached pivotally to the top of the chest (90) and has an edge.

The locking strip (92) is mounted slidably inside the chest (90) at the rear and has a top end, a front surface and multiple hooks (922). The top of the locking strip (92) is connected pivotally to the edge of the top cover (91). The hooks (922) are formed on and protrude from the front surface of the locking strip (92) and face down.

The drawers (93) are mounted slidably respectively in the drawer openings in the chest (90), and each drawer (93) has an inner end and an end wall (932). The end wall (932) protrudes up from the inner end of the drawer (93) and has a top edge. The top edges of the end walls (932) are selectively engaged respectively by the hooks (922) on the locking strip (92) to hold the drawers (93) in the chest (90).

When the top cover (91) is opened, the locking strip (92) is pulled up. The hooks (922) on the locking strip (92) disengage from the top edges of the end walls (932) of the drawers (93), and the drawers (93) can be pulled out of and pushed completely into the chest (90).

When the top cover (91) closes, the locking strip (92) slides toward the bottom of the chest (90). The hooks (922) of the locking strip (92) engage the top edges of the end walls (932) of the drawers (93) and lock the drawers (93) in the chest (90).

However, the top cover (91) must be open for the drawers (93) to be pulled out or pushed completely into the chest (90). When the top cover (91) is opened, the top cover (91) is easily deformed. Furthermore, the top cover (91) easily drops inadvertently and may hurt users.

When the top cover (91) is closed, the drawers (93) not pushed completely into the chest (90) will not be locked inside the chest (90) and may slid out of the chest (90). The drawers (93) that slide out of the chest (90) may injure people near the chest (90) and damage tools in the drawers (93). To ensure that the drawers (93) are securely locked in the chest (90), the top cover (91) must be open, and each drawer (93) must be pushed completely into the chest (90). Then the drawers (93) will be locked in the chest (90) after the top cover (91) is closed. However, opening and closing the top cover (91) every time a tool needs to be changed is very inconvenient and leads to bad working habits such as leaving tools around a work area.

Because the chest (90) is formed by welding multiple panels together, the chest (90) is not strong enough and is difficult and expensive to manufacture.

To overcome the shortcomings, the present invention provides a mobile tool chest with a safety device to obviate or mitigate the aforementioned problems.

### SUMMARY OF THE INVENTION

The primary objective of the present invention is to provide a mobile tool chest with a safety device that has a top cover, is strong, is easy to manufacture and locks drawers even when the top cover is closed before the drawers are pushed completely into the chest.

The mobile tool chest with a safety device in accordance with the present invention has a chest, a top cover, locking strips and drawers. The chest has a top and is fabricated from a single piece of folded sheet metal. The top cover is attached pivotally the top of the chest and is fabricated from a single piece of folded sheet metal. The locking strips are mounted slidably inside the chest and are connected slidably to the top cover, and each locking strip has a front surface and multiple locking holes. The locking holes are formed through the front surface of the locking strips. The drawers are mounted slidably in the chest, and each drawer has a rear end and at least one locking hook. The locking hooks are mounted on and protrude from the rear end of the drawers and engage the locking holes in the locking strips when the top cover is closed. When the top cover is closed, the locking strips are pushed up by the locking hooks when a drawer is pushed completely into the chest and drop down to lock the drawers in the chest. Consequently, the drawers are not a hazard to people near the mobile tool chest.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a mobile tool chest with a safety device in accordance with the present invention;

FIG. 2 is a perspective view of the mobile tool chest with a safety device in FIG. 1 with the top cover open;

FIG. 3 is an enlarged partially exploded perspective view of a locking strip connected to the top cover of the tool storage with a safety device in FIG. 2 with the top cover open;

FIG. 4 is an enlarged cross sectional side view of a locking strip connected to the top cover of the tool storage with a safety device in FIG. 3;

FIG. 5 is an enlarged cross sectional side view of a locking strip connected to the top cover of the tool storage with a safety device in FIG. 1 with the top cover closed;

FIG. 6 is a perspective view of a conventional mobile tool chest in accordance with the prior art;

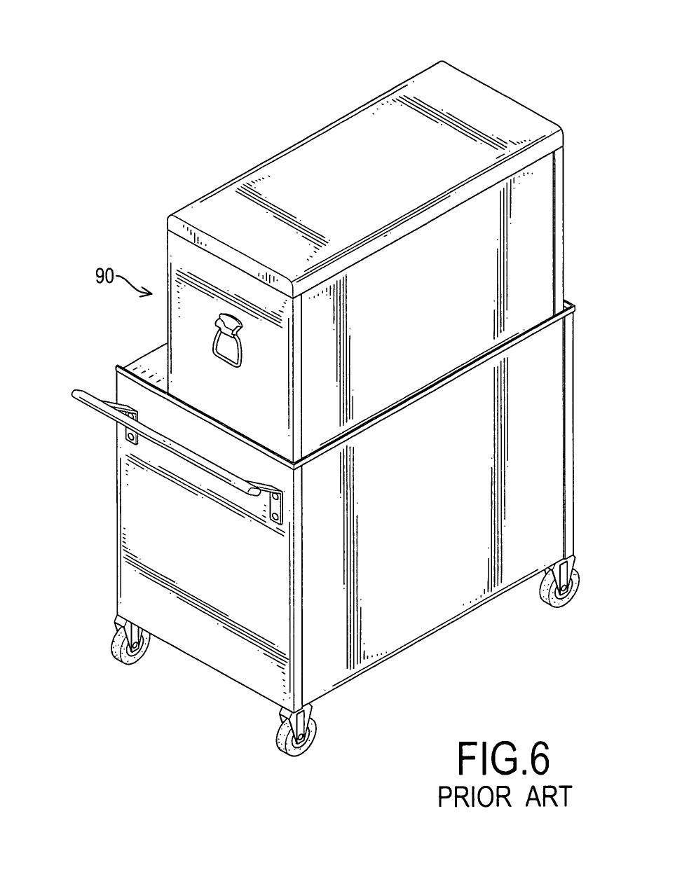

FIG. 7 is an enlarged partially exploded perspective view of the mobile tool chest in FIG. 6 with the top cover open; and

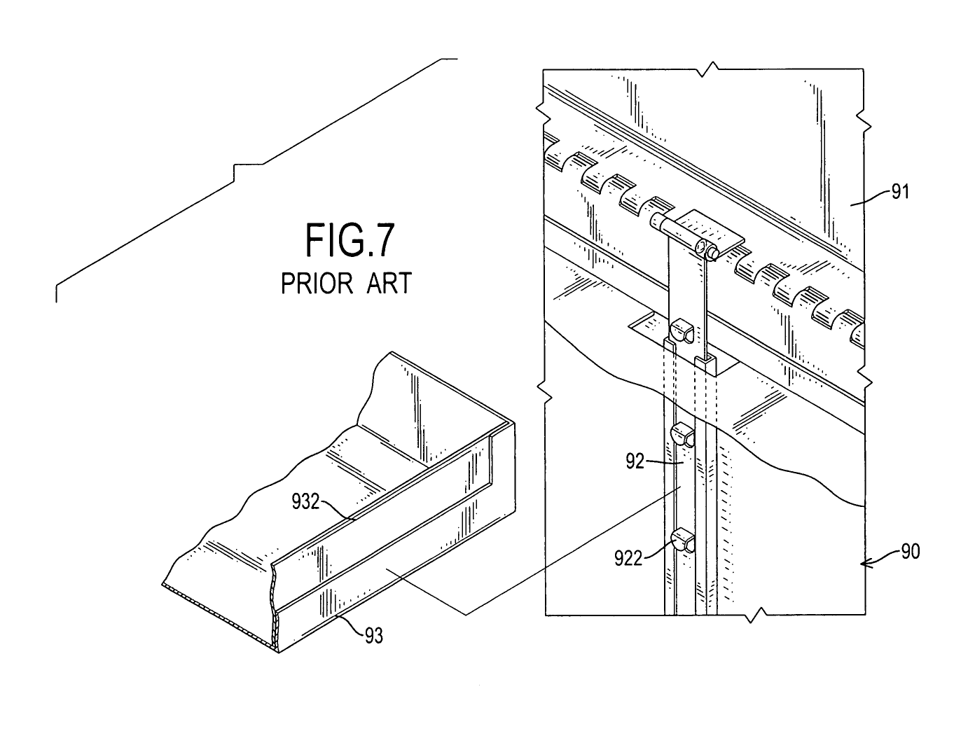

FIG. 8 is an enlarged operational cross sectional side view of the mobile tool chest in FIG. 6.

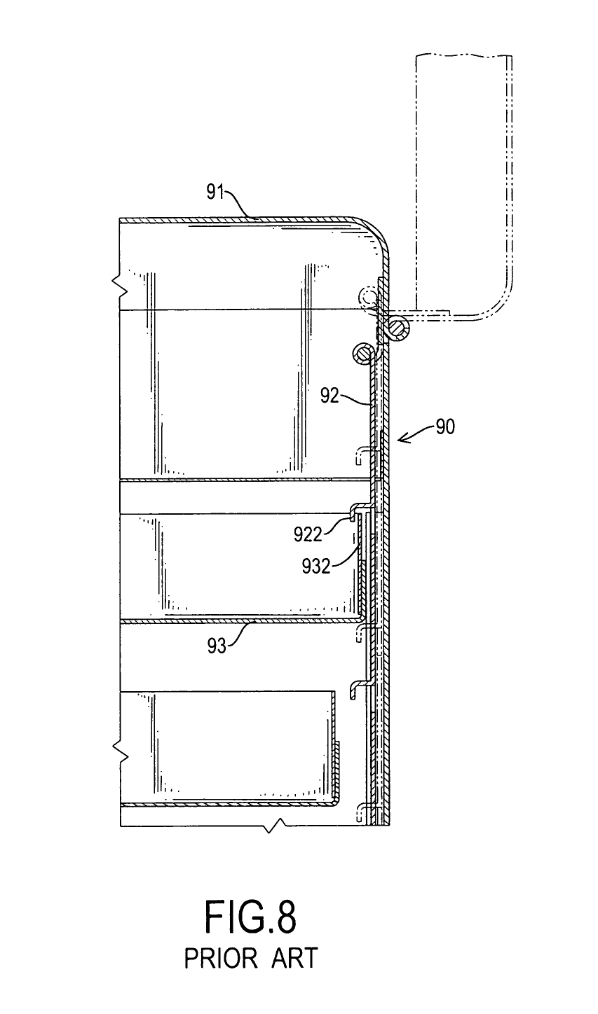

### DETAILED DESCRIPTION OF THE PREFERRED EMBODIMENT

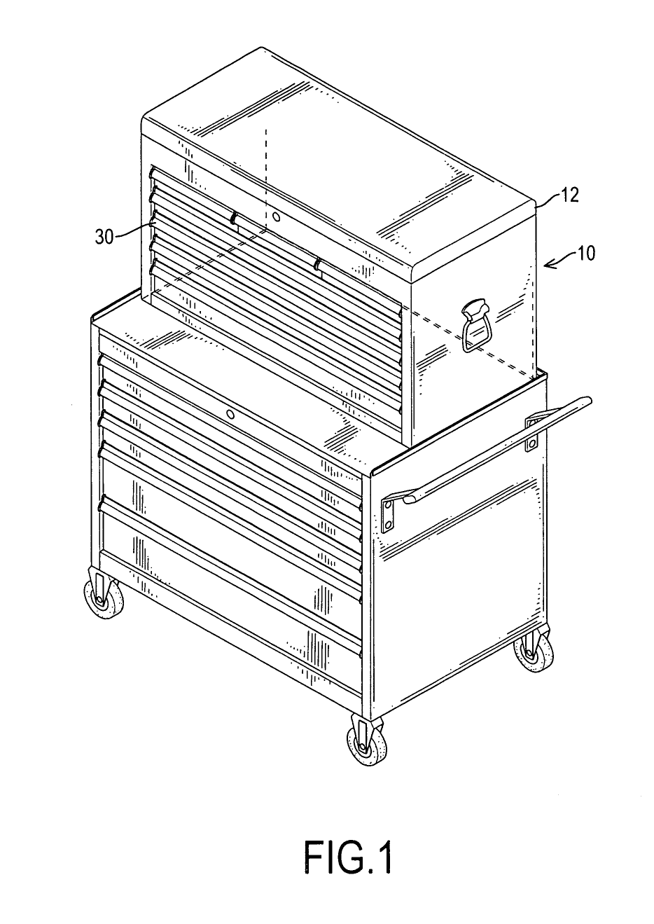

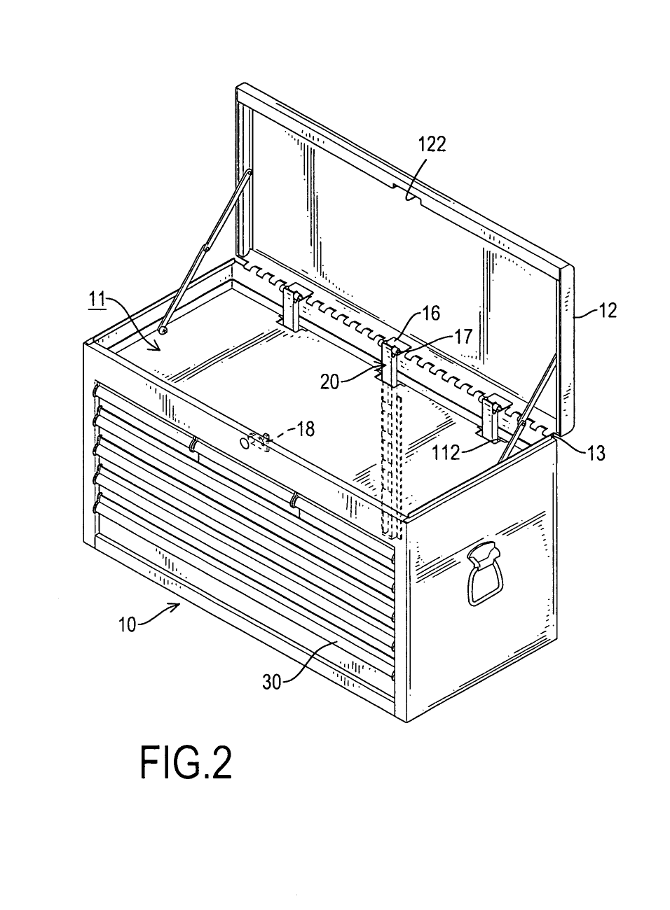

With reference to FIGS. 1 and 2, a mobile tool chest with a safety device in accordance with the present invention comprises a chest (10), a top cover (12), at least one locking strips (20) and multiple drawers (30) and preferably has three locking strips (20).

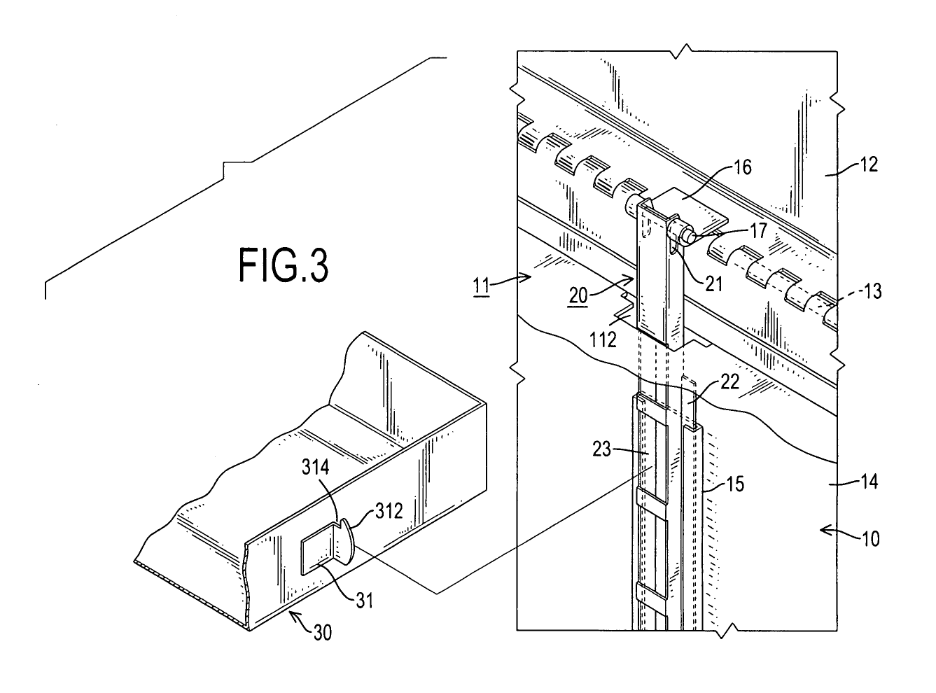

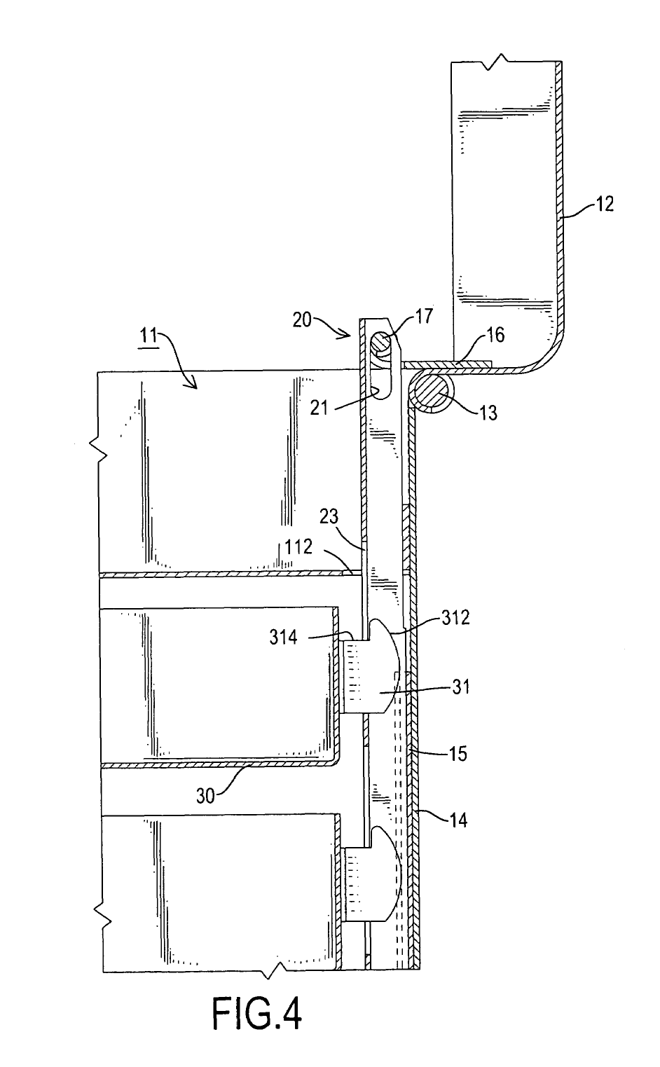

With further reference to FIGS. 3 and 4, the chest (10) may be formed from a single piece of sheet metal, has a top, a top cavity (11), a bottom, a front, a rear, multiple drawer openings, two optional side panels, a rear panel (14) and an optional locking hook (18) and preferably has five drawer openings. The top cavity (11) is formed at the top of the chest (10) and has a bottom and at least one through hole (112) and preferably has three through holes (112). The bottom of the top cavity (11) has a rear edge. The through holes (112) are formed through the rear edge of the top cavity (11). The drawer openings are formed through the front of the chest (10). The rear panel (14) has a top edge, an inner surface and at least one sliding track (15) and preferably has three sliding tracks (15). The sliding tracks (15) are attached vertically to the inner surface of the rear panel (14) and correspond respectively to the through holes (112) in the top cavity (11). The locking hook (18) is mounted rotatably through the front of the chest (10) at the top.

The top cover (12) may be formed from a single piece of sheet metal and has a front, a rear, an optional locking hole (122) and a hinge (13). The locking hole (122) is formed at the front of the top cover (12), corresponds to the locking hook (18) in the chest (10) and is engaged selectively by the locking hook (18) to lock the top cover (12) closed on the chest (10). The hinge (13) pivotally connects the rear of the top cover (12) and the top edge of the rear panel (14) of the chest (10) and may be implemented with a conventional piano hinge or interleaving hinge barrels and a hinge pin. The interleaving hinge barrels are formed on top edge of the rear panel (14) and the rear of the top cover (12). The hinge pin is mounted in and pivotally connects the interleaving hinge barrels.

The locking strips (20) are slidably mounted respectively in the sliding tracks (15) and extend respectively through the through hole (112) in the top cavity (11), and each locking strip (20) has a connecting leaf (16), an inner surface, a top end, two sides, two elongated holes (21), a connecting pin (17), two optional guide rails (22) and multiple locking holes (23). The connecting leaves (16) are mounted inside the top cover (12) at the rear and correspond respectively to the through holes (112) in the top cavity (11) of the chest (10), and each connecting leaf (16) has a pivot hole. The pivot hole is formed through the connecting leaf (16). The two elongated holes (21) are formed respectively through the sides of the locking strip (20) near the top and are aligned with each other. The connecting pin (17) pivotally connects the connecting leaf (16) to the corresponding locking strip (20) and is mounted in the pivot hole in the connecting plate (16) and slidably in the two elongated holes (21) in the locking strip (20). The guide rails (22) are formed respectively on and protrude out from the sides of the locking strip (20) and slide in the corresponding sliding track (15) in the chest (10) so that the locking strip (20) maintains vertical alignment and does not pull away from the rear panel (14). The locking holes (23) are rectangular and are formed through the inner surface of the locking strip (20), and each locking hole (23) has a top edge.

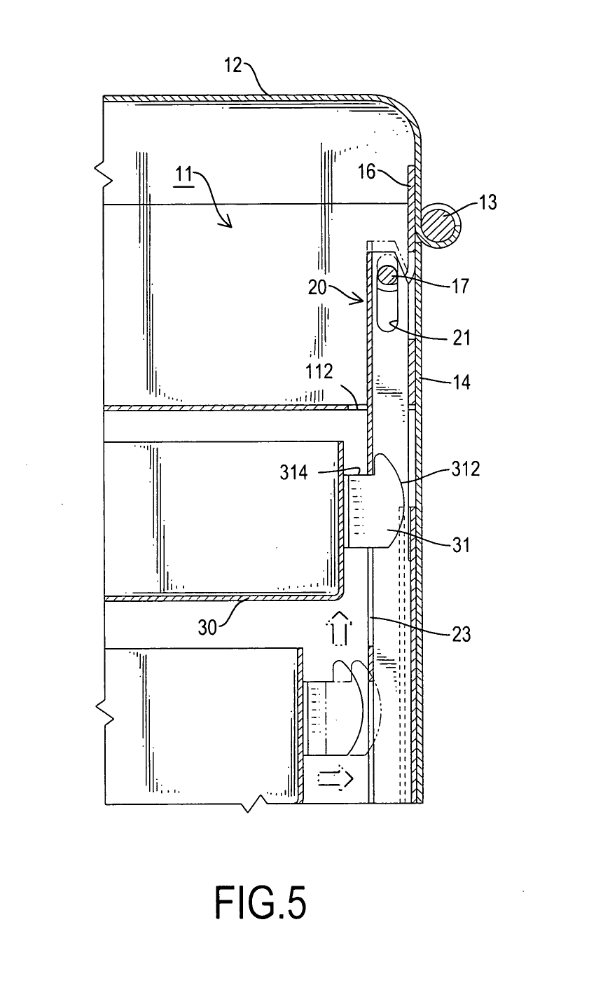

The drawers (30) are mounted slidably in the chest (10) through the openings in the chest (10) with three drawers (30) preferably mounted slidably through each opening, and each drawer (30) has a rear end and a hook (31). The hook (31) is mounted on and protrudes from the rear end of the drawer (30), corresponds to a locking hole (23) in the locking strip (20), extends into said locking hole (23) when the drawer (30) is pushed completely into the chest (10) and has a proximal end, a distal end, a top, an inclined edge (312) and a locking notch (314). The proximal end is connected to the rear end of the drawer (30). The inclined edge (312) is formed on the distal end of the hook (31) at the top and presses the top edge of the locking strip (20) up as the hook (31) is pressed into the locking hole (23). With further reference to FIG. 5, the locking notch (314) is formed on the top of the hook (31) between the proximal end and the inclined edge (312), engages the top edge of the corresponding locking hole (23) of the locking strip (20) when the hook (31) is pressed into the locking hole (23) and the top cover (12) is closed, disengages from the top edge of the locking hole (23) when the top cover (12) is open and may be step-shaped.

The mobile tool chest as described has the following advantages. First, the chest (10) and the top cover (12) are made respectively from single pieces of sheet metal piece, which makes the chest (10) and the top cover (12) strong and easy to manufacture. Second, the drawers (30) can be pushed completely into and locked in the chest (10) even when the top cover (12) is closed because the elongated holes (21) in the locking strips (20) allow the locking strips (20) to be pushed up by the inclined edges (312) of the hooks (31) when the drawers (30) are pushed completely into the chest (10).

Even though numerous characteristics and advantages of the present invention have been set forth in the foregoing description together with details of the structure and function of the invention, the disclosure is illustrative only. Changes may be made in detail especially in matters of shape, size, and arrangement of parts within the principles of the invention to the full extent indicated by the broad general meaning of the terms in which the appended claims are expressed.

What is claimed is:

1. A mobile tool chest with a safety device comprising
a chest having
a top;
a top cavity being formed at the top of the chest and having
a bottom having a rear edge; and
at least one through hole being formed through the rear edge;
a bottom;
a front;
a rear;
multiple drawer openings being formed through the front of the chest; and
a rear panel having
a top edge;
an inner surface; and
at least one sliding track being attached to the inner surface of the rear panel and corresponding respectively to the at least one through hole in the top cavity;
a top cover having
a front;
a rear; and
a hinge pivotally connecting the rear of the top cover to the top edge of the rear panel;
at least one locking strip being slidably mounted respectively in the at least one sliding track and extending respectively through the at least one through hole in the top cavity, and each one of the at least one locking strip having
a connecting leaf mounted inside the top cover at the rear, corresponding to one of the at least one through hole in the top cavity and having a pivot hole formed through the connecting leaf;
an inner surface;
a top end;
two sides;
two elongated holes formed through the sides of the locking strip near the top and being aligned with each other;
a connecting pin pivotally connecting the connecting leaf to the locking strip and being mounted in the pivot hole in the connecting plate and slidably in the two elongated holes of the locking strip; and
multiple locking holes formed through the inner surface of the locking strip, and each locking hole having a top edge;
multiple drawers being mounted slidably in the chest through the drawer openings in the chest, each drawer slidely mounted at one of the drawer openings of the chest and having
a rear end; and
a hook mounted being mounted on and protruding from the rear end of the drawer, corresponding to a corresponding one of the locking holes in a corresponding one of the at least one locking strip, extending into the corresponding locking hole when the drawer is pushed completely into the chest and having
a proximal end being connected to the rear end of the drawer;
a distal end;
a top;
an inclined edge being formed on the distal end of the hook at the top at the top to press the top edge of the corresponding locking strip up as the hook is pressed into the locking hole; and
a locking notch being formed on the top of the hook between the proximal end and the inclined edge and engaging the top edge of the corresponding locking hole when the hook is pressed into the corresponding locking hole and the top cover is closed and disengaging from the top edge of the corresponding locking hole when the top cover is open.

2. The mobile tool cabinet as claimed in claim 1, wherein each locking strip further has two guide rails being formed respectively on and protruding out from the sides of the locking strip and sliding in a corresponding sliding track in the cabinet.

3. The mobile tool cabinet as claimed in claim 1, wherein
the top cavity has three through holes; and
the rear panel of the chest has three sliding tracks.

4. The mobile tool cabinet as claimed in claim 1, wherein
the chest further has a locking hook being mounted rotatably through the front of the chest as the top; and
the top cover further has a locking hole being formed at the front of the top cover, corresponding to the locking hook in the chest and being engaged by the locking hook to lock the top cover closed on the chest.

5. The mobile tool cabinet as claimed in claim 1, wherein three drawers are mounted slidably through the drawer openings.

6. The mobile tool cabinet as claimed in claim 1, wherein the locking notch on each hook is step-shaped.
